(19) United States
(12) Patent Application Publication
(10) Pub. No.: US 2007/0061185 A1
(43) Pub. Date: Mar. 15, 2007

(54) METHOD, SYSTEM, AND COMPUTER PROGRAM PRODUCT FOR IMPLEMENTING AVAILABILITY MESSAGING SERVICES

(75) Inventors: Daniel J. Peters, Poughquag, NY (US); Edward W. Armstrong, Chapel Hill, NC (US); Joseph P. DeMarco, Newburgh, NY (US); Robert A. Glassberg, Poolesville, MD (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/162,427

(22) Filed: Sep. 9, 2005

(51) Int. Cl. G06F 17/30

(52) U.S. Cl. 705/10

(57) ABSTRACT

A method, system, and computer program product for implementing availability messaging services is provided. The method includes associating a user with an audience type with respect to an entity. The entity provides at least one product or service. The method also includes defining and applying at least one domain to each audience type operable for differentiating among audience types. In response to receiving a request for availability information regarding the product or service, the method includes determining a corresponding schedule date for the product or service. The method further includes converting the schedule date to a lead time to ship date and/or lead time to arrival date, and generating an availability message based upon the audience type of the user. The availability message includes the lead time to ship date and/or the lead time to arrival date.

### BACKGROUND OF THE INVENTION

The present invention relates generally to messaging services and, more particularly, to a method, system, and computer program product for implementing product and/or service availability messaging services.

In today's competitive environment companies are looking beyond product and price to develop an edge on their competitors. Providing information about the availability of a product or service has become one of the major influencers in the buying decisions of customers. This availability information is often provided to customers based on batch files that are updated daily, although newer processes may provide availability information more frequently. There are also processes that provide updates based upon a change in the supply information that affects product/service availability.

The pressure on companies to reduce costs has also impacted the way product/service availability information is calculated and displayed. Manufacturers typically keep their supply of materials at a component or building block level in order to provide the most flexibility in producing the various configurations of products that customers require while reducing the cost of inventory. This change from stocking the material at a finished good (build to plan) to an “assemble to order” environment has increased the complexity of calculating and displaying the availability for products. Instead of calculating availability based on whether the product is in stock or on order, the calculation now determines what components are in the product, and how many components are available (on hand or available from suppliers) and how many products can be derived from those components. In addition, many products vie for the same components, and some service packages compete within a common resource pool.

For many business enterprises operating in the United States, there is oftentimes a tendency to “hide” certain machine types or models from prospective customers that have an availability of thirty days and greater due to an interpretation of the Federal Trade Commission (FTC) rules on taking credit card payments. These rules apply to a specific and protected group of consumers. With credit card limits rising and additional regulatory conditions attached to their use, organizations are required to generate and control availability messages sent to different countries, states, and audiences. By extension, these regulatory rules may be applied to other countries to simplify software development and implementation, even though there may not be the same legal requirements in those nations. The proliferation of one country's availability practices may impede commerce outside that country. Furthermore, while the “hide” concept may work to some degree for products available only in fixed configurations, a transition to the sales building block or feature code paradigm requires special care.

Hiding sales building blocks, feature codes, and options content in a business' catalog (learn experience) and configurator (shop experience) may impact the closing of a sale (buy experience) or the use of a promotion. Hiding sales building blocks and option content do not merit the associated value in meeting regulatory requirements. One negative consequence is that the customer may want to make a conscious decision to accept the long lead time item, but was not afforded the opportunity. In some cases, an entire product or service release would not be displayed to the customer, which is an unacceptable situation for both the seller and the consumer. Moreover, the enterprise would not be afforded an opportunity to sell another “equivalent or better” solution, i.e., to condition demand.

Additionally, there are regulatory requirements or practices in other countries that require some ability to control availability content based on legal considerations, language, current practices, etc. which are different from those of the headquarters of multinational companies. These legal restrictions or current practices would need to be controlled at a country or state (e.g., web store) level instead of at a worldwide or geography-wide level. For example, language content, promotions, pricing and taxation are controlled within most commerce applications at a country and state (e.g., web store) level. However, availability information has not been afforded the same capability.

What is needed, therefore, is a solution that provides product and/or service availability information that is uniquely customized for a particular audience and which takes into consideration the legal requirements of the particular audience, as well as other relevant criteria.

### SUMMARY OF THE INVENTION

The foregoing discussed drawbacks and deficiencies of the prior art are overcome or alleviated by a method, system, and computer program product for implementing availability messaging services.

A method, system, and computer program product for implementing availability messaging services is provided. The method includes associating a user with an audience type with respect to an entity. The entity provides at least one product or service. The method also includes defining and applying at least one domain to each audience type operable for differentiating among audience types. In response to receiving a request for availability information regarding the product or service, the method includes determining a corresponding schedule date for the product or service. The method further includes converting the schedule date to a lead time to ship date or lead time to arrival date, and generating an availability message based upon the audience type of the user. The availability message includes the lead time to ship date and/or the lead time to arrival date.

The system for implementing availability messaging services includes a host system in communication with a user system via a network and an application executing on the host system. The application performs a method. The method includes associating a user of the user system with an audience type with respect to an entity of the host system. The entity provides at least one product or service. The method also includes defining and applying at least one domain to each audience type operable for differentiating among audience types. The method further includes determining a corresponding schedule date for the product or service in response to receiving a request for availability information regarding the product or service, converting the schedule date to a lead time to ship date and/or a lead time to arrival date, and generating an availability message based upon the audience type of the user. The availability message includes the lead time to ship date and/or the lead time to arrival date. The method further includes transmitting the availability message to the user system.

A computer program product for implementing availability messaging services includes instructions for performing a method. The method includes associating a user with an audience type with respect to an entity. The entity provides at least one product or service. The method also includes defining and applying at least one domain to each audience type operable for differentiating among audience types. In response to receiving a request for availability information regarding the product or service, the method includes determining a corresponding schedule date for the product or service. The method further includes converting the schedule date to a lead time to ship date or lead time to arrival date, and generating an availability message based upon the audience type of the user. The availability message includes the lead time to ship date and/or the lead time to arrival date.

### BRIEF DESCRIPTION OF THE DRAWINGS

Referring to the exemplary drawings wherein like elements are numbered alike in the several FIGURES:

FIG. 1 is a block diagram of a system upon which the availability messaging services may be implemented in an exemplary embodiment;

FIG. 2 is a table illustrating a sample lead time to ship conversion of availability messages in an exemplary embodiment;

FIG. 3 is a flow diagram illustrating a process for implementing availability messaging services in an exemplary embodiment;

FIG. 4 is a diagram illustrating primary domain lead time to ship controls for all audiences in an exemplary embodiment;

FIG. 5 is a diagram illustrating secondary domain message tables for lead time to ship for all audiences in an exemplary embodiment;

FIG. 6 is a logic table that provides logic for application to the controls shown in FIG. 4 in an exemplary embodiment;

FIG. 7 is a diagram illustrating primary domain lead time to arrival controls for all audiences in an exemplary embodiment;

FIG. 8 is a diagram illustrating secondary domain message tables for lead time to arrival for all audiences in an exemplary embodiment;

FIG. 9 is a logic table that provides logic for application to the controls shown in FIG. 7 in an exemplary embodiment;

FIG. 10A-10C is a diagram depicting sample domains for a single primary domain and the relationship therebetween in an exemplary embodiment;

FIG. 11A-11B is a diagram depicting sample primary and secondary domains for multiple primary domains and the relationships therebetween in an exemplary embodiment;

FIG. 12 is a diagram depicting sample primary and secondary domains for multiple primary domains and the relationships therebetween in an exemplary embodiment; and

FIG. 13 is a diagram illustrating a primary domain lead time to ship controls for all audiences and which includes sample data in an exemplary embodiment.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DETAILED DESCRIPTION OF THE INVENTION

Disclosed herein is a method, system, and computer program product for implementing availability messaging services. The availability messaging system and services combine a set of processes, tools, and process architecture for providing control over, and customization of, availability messages targeted for different audiences.

The availability messaging system provides a fully integrated supply chain for an enterprise, which connects the interaction of customers, business partners, and internal sales staff and administrative support for various organizational elements of the enterprise, such as manufacturing and procurement groups. This integration, in turn, enables the customer, business partner, internal sales staff and administrative support, and the supply chain to manage and support one another, thereby making the enterprise more responsive and accessible to customers and business partners. An on demand supply chain must sense customer and business partner demand and respond quickly to the changing market place with credible availability information. To have the necessary agility in the market place, processes and applications must be supported by a robust set of rules, technologies and techniques to condition demand during the planning, development and execution phases.

In accordance with exemplary embodiments, the availability messaging system and services provide availability messages targeted for distinct audiences with varying degrees of permissions to view that availability information. These audiences may include entitled customers, non-entitled customers, business partners, and internal sales staff and administrative support. The invention uses a parameter file component with various controls and logic tables described herein to determine the appropriate availability message. In exemplary embodiments, availability information is provided by a scheduling application of the enterprise and is based on net available supply. From a scope perspective, availability information mirrors the scheduling engine's netted supply availability and rules over the life of a product or service (e.g., from general announcement to withdrawal from marketing).

For purposes of illustration, the availability messaging processes will be described with respect to a business enterprise. However, it will be understood by those skilled in the art that other types of organizations, such as nonprofit entities or the government sector, may implement availability messaging by modifying one or more of the Figures.

Various terms used throughout this description are defined below for clarification purposes.

Learn. In the ‘learn’ experience, the customer, business partner, distributor, or seller's (also referred to herein as ‘enterprise’) internal sales and administrative support staff browses the catalog, looking for suitable products and options. In the case of products, the customer may be seeking a suitable starting point for the shop or configuration experience. During the learn experience, the customer, business partner or internal sales staff may view the availability of the products, services and selectable options, either in batch mode or real time availability. If the product, service or option is satisfactory “as is,” the customer may proceed straight from the learn experience to the buy experience.

Shop. In the ‘shop’ experience, the customer, business partner, distributor, or seller's internal sales and administrative support staff customize or configure a product or service based on selectable options that are part of the offering. During the shop experience, the customer, business partner, or seller's internal sales and administrative support staff may view the availability of the selectable options, either in batch mode or real time availability. Once the customer, business partner, or seller's internal sales and administrative support staff is satisfied with the function, price and availability, they may proceed to the buy experience.

Buy. In the ‘buy’ experience, the customer, business partner, or distributor has made a selection from the learn and/or shop experiences, and is viewing the purchase list (also referred to herein as ‘shopping cart’). The customer, business partner, or seller's internal sales and administrative support staff may be provided with several options within the buying experience, such as saving the shopping cart, selecting a premium transportation, continue browsing or configuring, etc. During the buy experience within the shopping cart, the customer, business partner, or seller's internal sales and administrative support staff may view the availability of the selected products, either in batch mode or real time availability. The customer may also decide to select premium transportation, based on lead time to arrival information or transportation cycle times, depending on which methodology is utilized by the enterprise.

Availability. Availability is expressed as an informational message, usually as a lead time in days (either to ship or arrival) based on the seller's scheduling application and rules. Examples of availability messages include: “5 days,” “3 weeks,” “In Stock,” “Within 2 weeks,” “one to two weeks,” “contact the seller,” etc. Considerations in determining availability may include source of supply, quantity, and type of availability presentation (e.g., batch or real time). An availability message may be formatted for display on any type of communications device, such as a telephone, computer, laptop, personal digital assistant, cellular telephone, etc. The selection of “ship” or “arrival” lead times may be based upon the seller's current practices and the scheduling application used by the enterprise. The view of availability may vary depending on the audience.

Public Customer. A public customer (also referred to as a “non-entitled” customer) does not have a contractual relationship with the seller. This customer typically shops anonymously until he/she is prepared to buy. The public customer is unknown until, e.g., “ship to” and “payment” information is provided to the seller. The presentation of availability to a public customer is expressed as a lead time message.

Entitled Customer. An entitled customer is one that has a special relationship with the seller with respect to items, such as products, services, availability, and pricing. In some cases, this customer may prefer a reduced version of the seller's product catalog based on a contractual relationship between the buyer and seller, specifically for those products and services that have pricing discounts and service level agreements. The entitled customer provides identification during the learn, shop, and buy experiences in order to view the respective contractual entitlements. The presentation of availability to an entitled customer may be expressed as a lead time message. An entitled customer's availability message may be indicate a shorter lead time than that of a public customer due to customer tiering with the enterprise's scheduling engine or application.

Business Partner. A business partner is an intermediate sales team/individual between the seller and ultimate buyer. The business partner enjoys a contractual relationship with the seller, and sometimes with the buyer. The contractual relationship with the buyer may include special pricing and other terms and conditions of mutual benefit. The business partner may have access to more information than would an entitled customer, but less than the seller's internal sales staff and administrative support (e.g., product sources of supply).

Distributor. A distributor refers to a special category of business partner who adds value to products, supports other business partners and customers, and may be a source of supply or fulfillment center for the seller. Distributors may provide availability information to the seller either as a lead time or stockage indicator (in stock, out-of-stock, etc.).

Internal Sales Staff and Administrative Support. The internal sales staff and administrative support may include the seller's face-to-face sales teams, account teams with more than one customer, customer service representatives, sales support teams, and/or TeleSales representatives. The internal sales staff may be authorized to view buyer and internal information based upon a successful log in.

User. A user of the availability messaging processes may be a public customer, a registered customer or an entitled customer (hereinafter collectively referred to as “customer”) seeking to make a purchase, a business partner or distributor seeking to make a purchase and/or seller's sales staff assisting in the making of a purchase.

Audience. Audiences refer to the intended recipients of the availability messages and may be defined by the route-to-market or channel (i.e., business partners, direct sales, etc.), business partner tier (i.e., distributor, class of business partner, etc.), entitled customer size (e.g., large, medium, or small), sectors or industries (e.g., financial, pharmaceuticals, government, etc.), or a combination of the above. The enterprise may designate its audiences based on organizational and market strategies.

Domain. Domains are classified into levels, e.g., primary, secondary, tertiary, etc.). A primary domain refers to a top tier geographic segmentation of markets (e.g., North America, Asia-Pacific, etc.). A secondary domain may relate to a specific country and/or language requirements. For example, for a primary domain ‘America’, corresponding secondary domains might include the United States, Mexico, Canada-English, and Canada-French.

Commerce Engine. A commerce engine refers to a network-based application (e.g., web-based application) that provides customers, business partners, distributors, and internal sales staff and administrative support with the ability to view products and services (e.g., pictures and descriptions), obtain prices, and purchase products and services on line.

Customer Tiering. Customer tiering refers to a method for differentiating customers into groups or tiers in order to provide a different level of service e.g., the customer's significance to the enterprise. Supply capabilities may also be allocated to different tiers which may result in different availability lead times.

Net Available Supply. Net available supply refers to the remaining amount of supply available for customers to purchase over time after the current order backlog is subtracted from an initial supply position.

Availability Messages. Availability messages refer to information presented to a customer, business partner or internal sales staff or administrative support person representing the availability of a product or service. The availability messaging services convert the availability information from a schedule date to a date when a product is going to be shipped or delivered. The converted information is then entered into the availability message. The form of the message may be a numeric lead time or a simple message.

Methods of Scheduling. A scheduling method may be based on lead time, supply line, or manual calculations and is used to obtain a delivery date or ship date for a product or service.

Lead time to shipment. Lead time to shipment refers to an availability message describing the lead time (in days or weeks) required to ship a product or service from the provider. When days are used, the seller may further specify calendar or work days.

Lead time to arrival. Lead time to arrival refers to an availability message describing the lead time (in days or weeks) required to deliver a product or service from the provider to the buyer. When days are used, the seller specifies calendar or work days. One method of calculating the lead time to arrival is to add the lead time to ship and transit times together.

Methods of delivery. A method of delivery refers to the vehicle by which the product or service is delivered to the buyer (e.g., standard delivery, premium transportation, software download, etc.). The mode of delivery is one factor in determining an appropriate availability message (lead time to arrival).

Ordering Methods. Products and services may be ordered using a variety of methods (e.g., Web, TeleSales, B2B, EDI, Fax, etc.).

Product. A product refers to a tangible entity that has economic utility, satisfies an economic want, or possesses intrinsic value (excluding financial instruments) that is available for monetary or other compensation.

Service. A service relates to a useful labor or activity. Examples of services include a warranty, post sales support, consulting, training, transportation, managed operations, etc. A service is available for monetary or other compensation.

Batch Availability. Batch availability refers to the use of a batch feed to update availability information for products and services within a commerce engine. The availability may be based on a quantity of one or on a statistical going rate. The update may occur one or more times during the day.

Real Time Availability. Real time availability refers to a transaction that provides a synchronous response back within seconds to a requester regarding when a specific quantity of selected products or services will be shipped or delivered.

Up-sell. An up-sell opportunity refers to a situation whereby a customer or business partner is sold a more richly configured solution within the same good or service family above the customer's selected price range that satisfies the availability requirement. Incentives may be used to entice customers to agree to an up-sell.

Alternative-sell. An alternative-sell relates to a sale of a similar good or service to the customer or business partner that falls within the customer's selected price range and which satisfies the availability requirement. An alternative-sell is typically performed when an up-sell is not available and/or the customer opts for a similarly priced good or service.

Down-sell. A down-sell opportunity refers to a sale of a less capable alternative to the customer or business partner that falls below the selected price range and satisfies the availability requirement. A down-sell usually performed as a last resort (e.g., to save the sale) when an up-sell or alternative-sell is not available, or when the customer demands a lower-priced good or service.

Cross-sell. A cross-sell opportunity provides complimentary goods and services based on the goods or services the customer has selected. Examples include shipping, warranty, accessories, or peripherals. Volume discounts may apply to cross-sell items.

Primary Control. Primary controls are inputted into a parameters file component by the enterprise (e.g., a supply management team established by the team responsible for a corresponding primary domain) and set the upper and lower parameters for the primary domain. A “Contact the Seller” message may be returned when the availability is greater than the upper primary domain control. The upper primary domain control establishes the principal boundary or threshold to publish a “Contact the Seller” message for all secondary domains and organizational elements. A “Contact the Seller” message may be suppressed when the availability is less than or equal to the minimum threshold control parameter control. The minimum threshold control parameter ensures that if a secondary or tertiary control error is made, the primary control will suppress the error. The primary controls require a numeric element in their respective data fields. An example of a primary domain is an area defined by geographic features or political borders.

Secondary Control. Secondary controls are inputted into the parameters file component by the enterprise (e.g., a supply management team established by the team responsible for a corresponding secondary domain and organizational elements) and provide a refined definition on when to display a “Contact the Seller” message. The secondary controls may reflect the legal requirements and practices of the secondary domains and organizational elements. The secondary controls require a numeric element in their respective data fields. Examples of secondary controls may include organizational elements or secondary domains and sub areas within a political border, languages spoken, etc. A secondary domain may be further subdivided by language. Canada, for example, may have two secondary domains: Canada (English) and Canada (French).

Tertiary Control. Tertiary controls are inputted into the parameters file component by the enterprise (e.g., by a supply management team established by a cross-functional team responsible for a corresponding secondary domain and organizational elements) and provide an opportunity to override the secondary controls within the secondary domain and organizational element matrix. Tertiary controls are typically used on a temporary basis depending on unique circumstances and permit the most refined ability to control the “Contact the Seller” message. For example, there may be a significant difference between the organizational element and the secondary domain that can only be resolved via a tertiary control (e.g., a compromise position) for one element of the secondary domain and organizational element matrix. The tertiary controls default is blank or null. To provide the override function, the tertiary control requires a numeric element in the specific data field.

Organizational Element. An organizational element refers to a subordinate entity of the seller. Examples of organizational elements include brands, business units, product families, etc. Organizational elements may include customer tiers that allow differentiation of availability messaging for preferred customers.

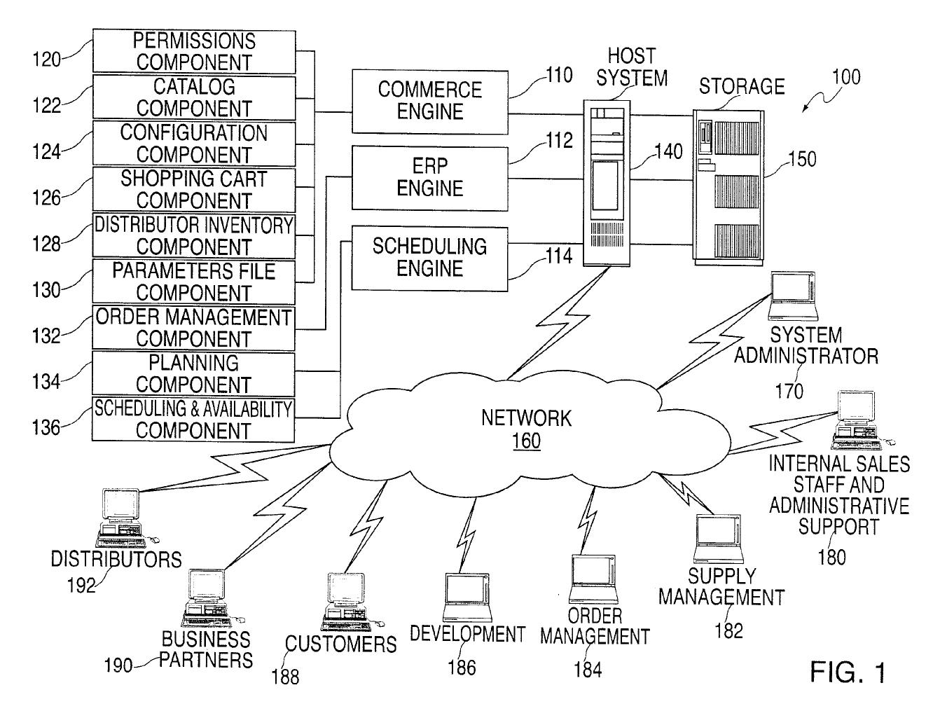

Turning now to FIG. 1, a network system 100 upon which the availability messaging services may be implemented will now be described. System 100 includes a host system or server 140 executing a commerce engine 110, enterprise resource planning (ERP) engine 112, and scheduling engine 114. The commerce engine 110 includes a permissions component 120, catalog component 122, configuration component 124, shopping cart component 126, distributor inventory component 128, and parameters file component 130. ERP engine 112 includes an order management component 132. Scheduling engine 114 includes planning component 134 and a scheduling and availability component 136. For purposes of illustration, non-web components of the host system 140 may utilize IBM's Lotus 1-2-3™ spreadsheets, DB2° databases, or other suitable data intense manipulation programs. The host system 140 communicates with a storage system 150 and network 160 as described herein.

Host system 140 may be connected to the storage system 150 directly or via a network (e.g., network 160). Client systems include a system administrator system 170, an internal sales staff and administrative support system 180, a supply management system 182, an order management system 184, a development system 186, customer systems 188, business partner systems 190, and distributor systems 192. Host system 140 communicates with client systems 170-192 through network 160 or other suitable networks. The host system 140 may be implemented using one of more servers operating in response to a computer program stored in a storage medium accessible by the server. The host system 140 may operate as a network server (e.g., a web server) to communicate with the client systems 170-192. Host system 140 handles sending and receiving information to and from client systems 170-192 and can perform associated tasks. Host system 140 may execute various applications typically found in an enterprise environment.

Host system 140 may also operate as an application server. Host system 140 executes one or more computer programs to implement the availability messaging system processes and related functions. As previously described, it is understood that separate servers may be utilized to implement the network server functions and the application server functions. Alternatively, the network server, the firewall, and the application server may be implemented by a single server executing computer programs to perform the requisite functions.

Host system 140 may include an IBM® eServer™ (iSeries™, pSeries™, xSeries™ or zSeries™) or any other suitable commercially available computer systems depending on the scope of the implementation. The host system 140 may execute web server software designed to accommodate various forms of communications, including voice, video, and text typically utilized by large organizations. Any web server software or similar program that handles general communications protocols and transport layer activities could be used as appropriate for the network protocol in use. For purposes of illustration, host system 140 is running IBM's Lotus Domino™ and Lotus NoteS™ as its groupware applications software; however, any compatible e-mail-integrated, web-enabled collaborative software could be used.

Storage system 150 may be implemented using a variety of devices for storing electronic information. It is understood that storage system 150 may be implemented using memory contained in the host system 140 or it may be a separate physical device. The storage system 150 is logically addressable as a consolidated data source across a distributed environment that includes network 160. Information stored in the storage system 150 may be retrieved and manipulated via the host system 140. The storage system 150 includes a data repository containing documents, data, web pages, images, multimedia, etc. Further, storage system 150 stores configuration files (also referred to herein as page tokens). In an exemplary embodiment, the host system 140 operates as a database server and coordinates access to application data including data stored within the storage system 150.

The storage system 150 may comprise any form of mass storage device configured to read and write database-type data maintained in a file store (e.g., a magnetic disk data storage device). The storage system 150 may range from a single hard disk drive on a personal computer to a large storage system, e.g., IBM's Shark™. Of course, it will be appreciated that the storage system 150 may be one that consists of multiple disk subsystems which may be geographically dispersed and coupled via network architecture.

There is no positive requirement that the storage system 150 be maintained in one facility; to the contrary, the volume of information stored therein may dictate geographical dispersion and the like. The storage system 150 is logically addressable as a consolidated data source across a distributed environment such as network 160. The implementation of local and wide-area database management systems to achieve the functionality of the storage system 150 will be readily understood by those skilled in the art. Information stored in the storage system 150 may be retrieved and manipulated by a database manager and data mining software, such as IBM's DB/2° software. The storage system 150 provides a repository for a library of documents and data that are created and utilized by the availability messaging processes described herein.

Network 160 may be any type of known network including, but not limited to, a Local Area Network (LAN), a Wide Area Network (WAN), a global network (e.g., Internet), a Virtual Private Network (VPN), an intranet, or other network configuration known in the art. These networks may be implemented using a wireless network or physically connected to each other in a state of the art configuration. One or more of the client systems 170-192 may be coupled to the host system 140 through multiple networks (e.g., intranet and Internet) so that not all clients systems 170-192 are coupled to host system 140 through the same network. One or more of the client systems 170-192 and the host system 140 may be connected to the network 160 in a wireless fashion. For example, one or more client systems 170-192 may execute a user interface application (e.g., a web browser) to contact the host system 140 through the network 160, while another client system is directly connected to the host system 140. Further, the network may include wireless connections, radio based communications, telephony based communications, Blackberries, and other network-based communications. Secure Socket Layer (SSL encryption) software may be used to control access to host system 140, limiting permissions to network users, such as remote client systems or third party systems, which have proper authorization.

In exemplary embodiments, the commerce engine 110 is a web-based application that provides customer systems (e.g., entitled and non-entitled) 188, business partner systems 190, distributors systems 192, and internal sales staff and administrative support system 180 with the ability to view products and services (e.g., pictures and descriptions), obtain prices, and purchase products and services on line. In exemplary embodiments, the commerce engine 110 is managed by the internal sales staff and administrative support system 180 of the enterprise.

In exemplary embodiments, the ERP engine 112 is an automated system that manages numerous organizational functions, including the order management component 132. In exemplary embodiments, orders are submitted from the commerce engine 110 to the ERP engine 112 for production and fulfillment processing. The ERP engine 112 passes key order attribute information to the scheduling engine 114. The ERP engine 112 may be managed by an order management system 184 of the enterprise.

In exemplary embodiments, the scheduling engine 114 is an automated system that receives key order attribute information from the ERP engine 112. The scheduling engine 114 may be managed by a supply management system 182 of the enterprise.

In accordance with exemplary embodiments, the components 120-136 utilized by the host system 140 will now be described.

The permissions component 120 is an automated system that manages user log in and password entry into the commerce engine 110 for internal sales staff and administrative support system 180, development system 186, customers systems 188, business partners systems 190, and distributors systems 192. Permissions component 120 provides protection to key information and the appropriate entitled data to specific users. The permissions component 120 identifies users by their audience category. This component 120 may be managed by internal sales staff and administrative support system 180.

The catalog component 122 is an automated system that provides product and services information during the learn experience for internal sales staff and administrative support system 180, customers systems 188, business partners systems 190, and distributor systems 192. The product and services offering information is provided and managed by the development system 186. Batch and real time availability from the scheduling application component 136 is provided to the catalog component 122. Product and services offering information is transmitted from the catalog component 122 to the configuration component 124 or the shopping cart component 126.

The configuration component 124 is an automated system used for customizing product and service offering information during the shop experience tailored to the needs of internal sales staff and administrative support system 180, customers systems 188, business partners systems 190, and distributors systems 192. The configuration component 124 may be devised and managed by development system 186. Batch and real time availability from the scheduling and availability component 136 is provided to the configuration component 124. Product and services offering information from the catalog component 122 may be processed through the configuration component 124 and transmitted to the shopping cart component 126.

The shopping cart component 126 is an automated system used to hold and submit order entry information during the buy experience for internal sales staff and administrative support system 180, customer systems 188, business partner systems 190, and distributor systems 192. The shopping cart component 126 may be managed by internal sales staff and administrative support system 180. Batch and real time availability from the scheduling and availability component 136 is provided to the shopping cart component 126. The shopping cart component 126 also receives fulfillment information such as payment method, ship to address, billing, etc. When the completed order is submitted, it is transmitted to the ERP engine 112.

The distributor inventory component 128 is an automated system that receives product availability information on a periodic basis from distributor systems 192. This information is used within the commerce engine 110 by internal sales staff and administrative support system 180 to satisfy order requirements from customers systems 188 and business partners systems 190. The seller may either redirect the order to a distributor or buy back the product from the distributor. The distributor inventory component 128 may be managed by the internal sales staff and administrative support system 180.

The parameters file component 130 maintains the seller's rules and other application variables such that any substantial programming changes to the underlying architecture of the host system enterprise become unnecessary. The parameters file component 130 controls the display of availability messages via the commerce engine 110, and identifies users by audience category. The parameters file component 130 may be managed by the supply management system 182. The parameters file component 130 and its functionality is described further herein.

The order management component 132 is an automated system that provides order fulfillment information to the ERP engine 112 for processing, and includes order transactions as well as the management of orders from order entry through installation. The order management component 132 controls the order information among the commerce engine 110, ERP engine 112, and scheduling engine 114. This component 132 may be maintained by order management system 184.

The planning component 134 is an automated system that provides the initial supply position to the scheduling engine 114, which has been communicated by suppliers to the seller based on the demand forecast. Customers, distributors, and business partners may be assigned to tiers based on seller prioritization rules. Supply may be allocated based on current practices, e.g., geographies, customers, tiers, etc. The planning component 134 may be maintained by the supply management system 182.

The scheduling and availability component 136 is an automated system that determines product and service availability based on the rules of scheduling. The scheduling and availability component 136 is periodically updated based on, e.g., net available supply and the scheduling engine's 114 rules, such as customer tiering, allocations, brokering schema, etc. The availability statement follows the rules of scheduling and may be expressed as a lead time in days, lead time to ship and/or lead time to arrival. The scheduling and availability component 136 may be updated on a batch basis (e.g., one or more times per day) or in real time. The scheduling and availability component 136 may be maintained by supply management system 182.

As indicated above, the host system 140 communicates with client systems 170-192. For purposes of illustration, the client systems 170-192 shown and described in FIG. 1 represent computer devices, such as general-purpose computer devices that allow systems to connect to the network 160 and host system 140. However, it will be understood that client systems 170-192 may include other types of communications devices, such as telephones, cell phones, laptops, personal digital assistants, Blackberries, etc. Client systems 170-192 may access host system 140 via seller's web browsers located therein. Individuals and teams involved in the selling, marketing and merchandising goods or services perform specific roles throughout the described process. They may also communicate with one another as will now be described.

System Administrator system 170 refers to a client system operated by a system administrator or other suitable individual to manage the performance, operation, and maintenance of the host system 140, storage system 150 and networks 160 identified in the foregoing discussion.

An internal sales staff and administrative support group performs activities via system 180 and is tasked with the following responsibilities:

control and management of the permissions component 120 and shopping cart component 126 to ensure that customers, business partners, distributors and seller's staff view only pertinent information within the commerce engine 110 applications;

control of the distributor inventory component 128 to include receiving and viewing permissions;

entering orders by using the catalog, configuration and shopping cart components 122-126, respectively;

full authorized viewing of availability information including source of supply, distributor inventory and seller's supply quantities over a time horizon; and

determining the organization-wide audience policies and segmentation with supply management system 182.

A supply management team controls and manages the scheduling engine 114, the planning component 134, and the scheduling and availability component 136, which includes the development of net available supply, allocations, etc. These activities are performed via supply management system 182. Additionally, in consultation with internal sales staff and administrative support system 180, the supply management system 182 provides primary, secondary and tertiary controls to the parameters file component 130 to ensure the right availability messages are provided to the various audiences.

An order management team controls and manages the ERP engine 112 and the order management component 132 to receive orders from the shopping cart component 126 and transmit data to the scheduling engine 114. These operations are conducted via the order management system 184.

A development team creates the seller's offering in the catalog component 122 based on an approved product and service structure. Elements with the product structure that have alternatives in capability may be modified within the configuration component 124. The development team, via the development system 186, may be responsible for the data and systems that support the learn and shop experiences.

Customers of the enterprise view availability messages based on lead times and customer tiering throughout the learn, shop and buy experiences via one or more customers systems 188. Public (i.e., non-entitled) customers may view the seller's entire public catalog of products and services. Entitled customers may view the seller's public catalog or a customized catalog, which may display improved availability information based on tiering logic. Customers at customers systems 188 may enter orders via the catalog, configuration and shopping cart components 122-126, respectively.

Business partners view availability messages based on lead times and customer tiering throughout the learn, shop and buy experience via business partners systems 190. Business partners may also view the seller's supply quantities over a time horizon. Business partners may enter orders via the catalog, configuration and shopping cart components 122-126, respectively.

In exemplary embodiments, distributor groups view availability messages based on lead times and customer tiering throughout the learn, shop and buy experiences via distributors systems 192. Distributor groups may also view the seller's supply quantities over a time horizon. Distributors may provide their finished goods inventory feed on a periodic basis to the seller via distributors systems 192 and may enter orders via the catalog, configuration, and shopping cart components 122-126, respectively.

There may be intended and unintended consequences concerning availability messages raised by the end-to-end integration on various software applications, product families (e.g., differentiated handling of machine types, models, sales building blocks, feature codes, or options), audience categories, payment types, etc. The availability messaging processes described herein address these issues.

There may also be availability considerations for products from distributors or other third parties. Oftentimes, distributor or third-party availability is either readily available (in stock) or not in stock. However, in those cases where the distributor provides an availability data feed as a lead time or message, the availability messaging processes may be applied.

Key customers or business partners (potential audiences) that are designated into a higher customer tier may be provided with a different and improved availability view based on the allocation of products and services, as compared with public (non-entitled) customers. Authorized users such as business partners and internal sales staff and administrative support may also be provided with a view of supply line availability (rolling horizon). The availability messaging processes permit control at the audience level with respect to the message the seller wants to provide to each audience.

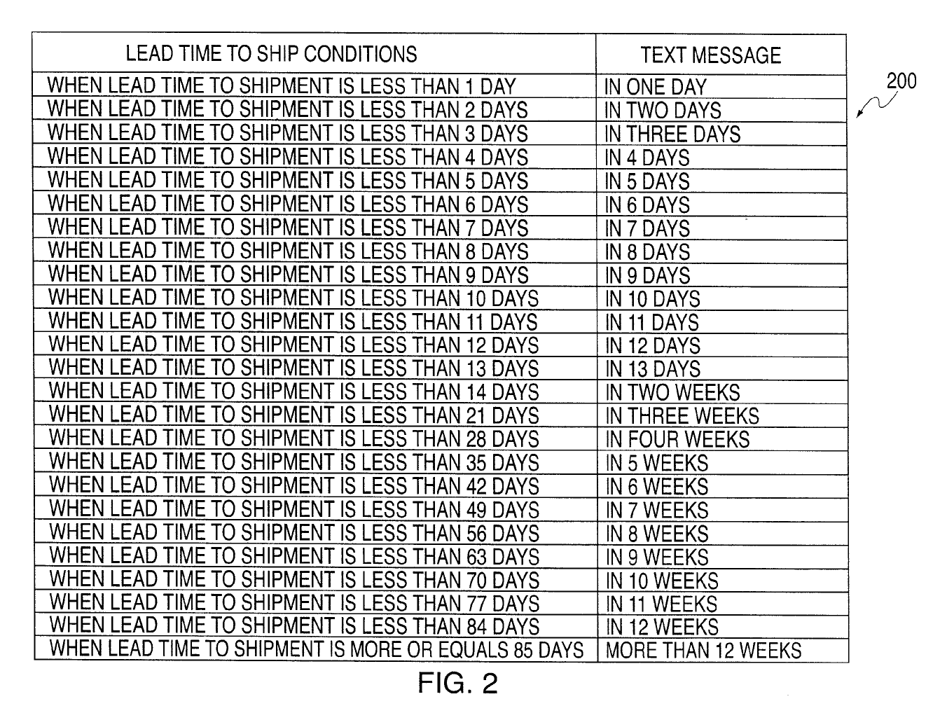

For multinational corporations, the primary and secondary geographic elements include lead time availability (either ship or arrival) to text conversion tables as to the text file to be displayed to customers. These tables may be set up via the commerce engine 110 and controlled by the geographic and organizational elements of the enterprise. For example, a lead time to ship of “3 days” may be displayed as “in 3 days” and a lead time to ship of “27 days” may be displayed as “in 4 weeks.” The availability messaging processes further provide control of messages at an audience level. The diagram depicted in FIG. 2 provides an example of differing types of messages converted from ship to lead times. This translation is performed within the parameters file component 130 of the commerce engine 110.

Demand conditioning drives customers and business partners who are still seeking constrained products to contact the seller to close the sale, either to up-sell, alternative-sell, down-sell or cross-sell a solution that solves a need. Other availability statements, e.g., “As Available” may be used for other purposes, such as end-of-life situations.

Based on rules, a display “Contact the Seller” for availability message may be established once a specific threshold has been met. A value of “Contact the Seller” is that the customer can still make a conscious “buy” decision based on availability, even though the selectable (sales building blocks or option) is constrained by regulations or practices in the catalog, configuration or shopping cart components 122-126, respectively. Geographic and organization element level capability for adjusting “Contact the Seller” thresholds may be driven by legal regulations and/or business policies. “Contact the Seller” messages may be displayed to the audiences as specified in the availability tables. These messages may include a means to contact the seller, e.g., internal phone numbers, toll-free phone numbers, e-mail address, instant messaging, etc.

From a process perspective, the scheduling engine 114 provides an availability date which the commerce engine 110 translates into a “lead-time-to-ship” or “lead-time-to-arrival,” which is subsequently translated into an availability message for displaying on the web (e.g., catalog and/or configuration components 122 and 124, respectively). The availability messaging processes provide the ability to override a Geography/Country file description with a “Contact the Seller” or equivalent message from the commerce engine 110. The availability messaging processes may also support multiple languages, differing relationships between primary and secondary domains, adapt to the complexity of the organization, calibrate the level of precision specified by the organization, and provide a degree of sophistication in the presentation of availability information.

In accordance with exemplary embodiments, availability information presented to a customer or sales support person is derived from a single trusted source, such as the scheduling engine 114 or the distributors' availability data feeds, as described further herein.

Availability information may be made available to a requester throughout the learn, shop and buy experiences. Specifically during the learn experience, the requester is in catalog browse mode, and is provided with availability information along with function and price. Availability, function, and price represent the three primary buying decision factors.

In the case of preparing a proposal, catalog availability may be used to establish a viable (non constrained) starting point. If that starting point requires no customization, then it may be placed into the shopping cart. If customization is required, the configurator (i.e., configuration component 124) is invoked. During configuration, the requester may be able to view availability information for those items that are configurable to that starting point and may make selections accordingly. After selections are made, the requester may place this configuration (i.e., customized starting point) into the shopping cart. At this point in the process, the requester may propose a solution (i.e., collection of items in the cart) with a level of confidence that the availability will meet customer shipment or arrival expectations.

Once the proposal is accepted, following any selection or configuration changes, the requester may perform a last check of availability to confirm that all of the items in the shopping cart remain unconstrained. By performing this check just prior to order placement, the occurrence of a customer receiving extended schedule date confirmations may be minimized.

The scheduling engine 114 provides schedule dates (shipment and/or arrival) to the commerce engine 110. The commerce engine 110 translates these “dates” to a lead time in days, and then translates these “days” to “availability messages.” Examples of possible messages include “5 days,” “3 weeks,” “In stock,” “within one week,” “one to two weeks,” “Contact the Seller,” etc.

The availability messaging processes support visibility of two general types of availability. The first type is batch availability (i.e., for a quantity of one or statistical going rate) provided one or more times per day from the scheduling engine 114 to the commerce engine 110. This view may be presented statically to all users throughout learn, shop and buy experiences. The quantity of one is the standard for batch availability. A statistical going rate (greater than one) may be substituted by the seller for batch availability based on key factors, such as demand variability, product replenishment cycle time, and the availability refresh cycle time.

The second type is real time availability (e.g., a call which is made to the scheduling engine 114 for availability of a quantity of one or greater). This call may be made at any time throughout the learn (e.g., during catalog browse), shop (e.g., during configuration), and buy (e.g., while in the shopping cart) experiences.

This process also recognizes two general types of requesters: a non-authorized user (public, large enterprise, or small/medium business customer), and an authorized user (seller sales representative or business partner). The non-authorized user's view of real time availability is a message, while the authorized view may be both the message and a view of the net available supply quantities over the planning horizon at that moment in time. Internal sales staff and administrative support of system 180 may also view the source of supply indicator and any finished goods inventory held at distributor locations, which is not seen by business partners.

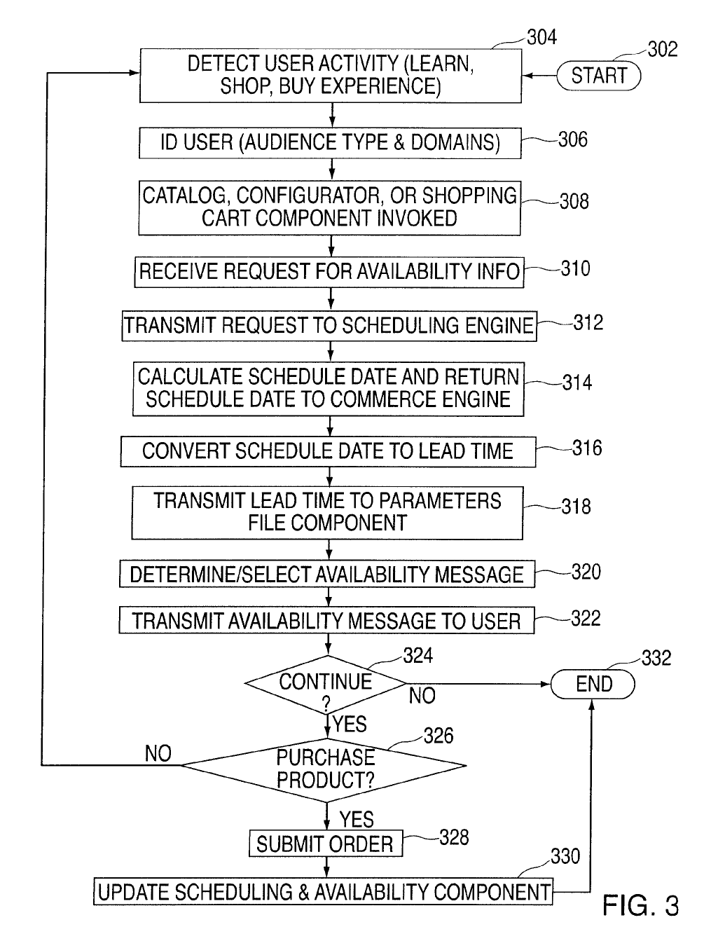

Turning now to FIG. 3, an exemplary process for implementing the availability messaging services will now be described. The enterprise initiates the process via host system 140 at step 302 by updating the components 120-136 identified in the system architecture 100 shown in FIG. 1. These component updates may be made on at least a daily, and possibly more frequent, basis depending on the dynamics of the data.

Specific responsibilities associated with these components have been identified previously and are briefly summarized herein. The internal sales staff and administrative support system 180 updates the permissions component 120, shopping cart component 126, and distributor inventory component 128. The development system 186 updates the catalog component 122 and configuration component 124. The order management system 184 updates the order management component 132. The supply management system 182 updates the parameters file component 130, planning component 134, and scheduling and availability component 136. No inference should be made concerning the aforementioned ordering or sequence of updates. It will be understood that the frequency and timing of these updates may be performed and sequenced based on the seller's established timetable.

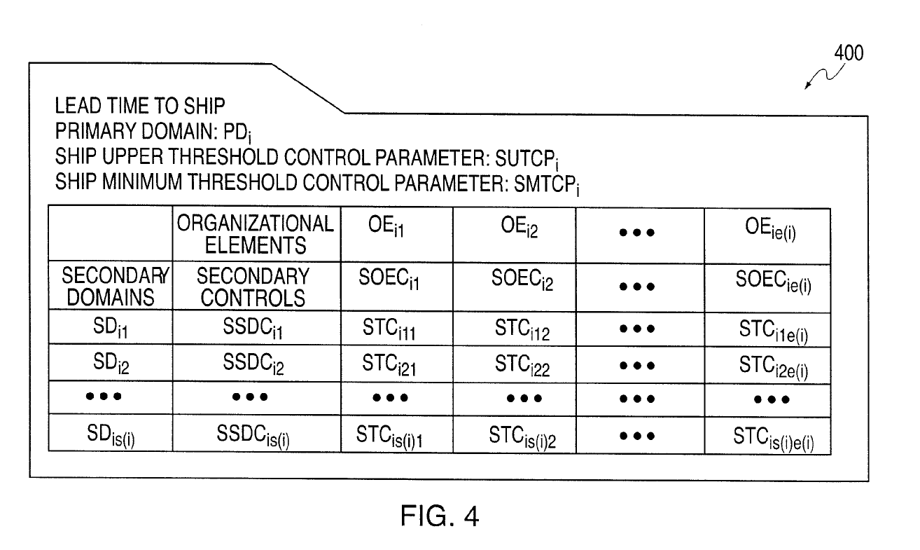

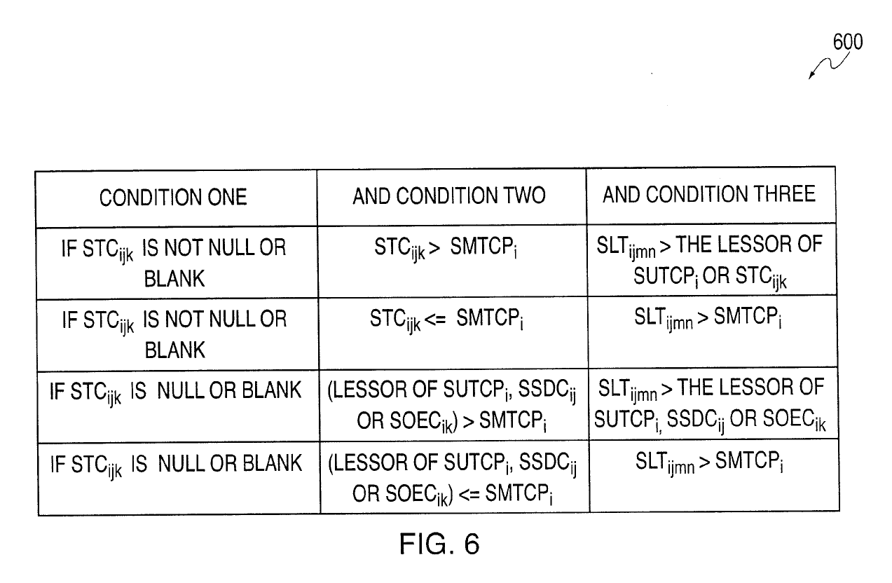

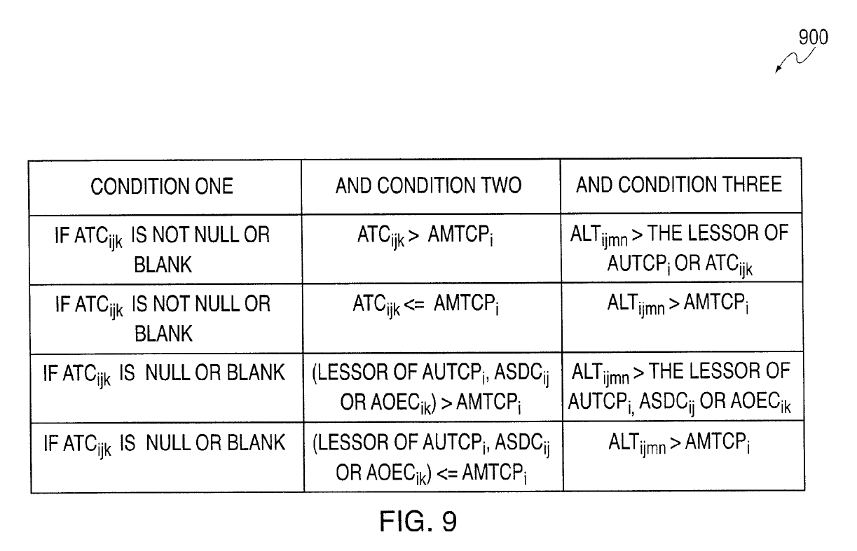

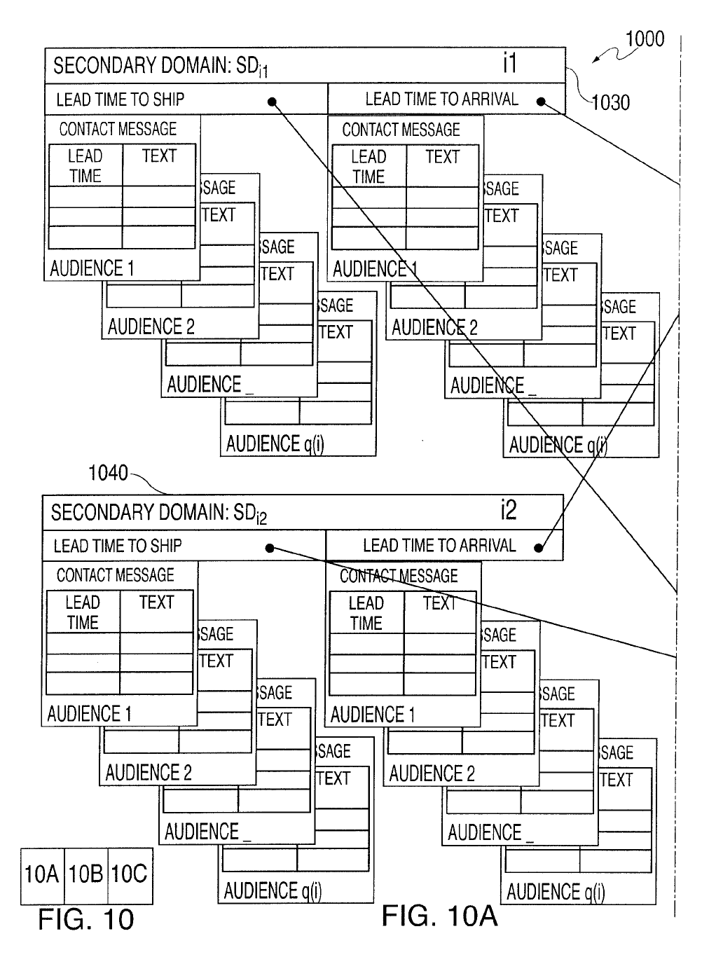

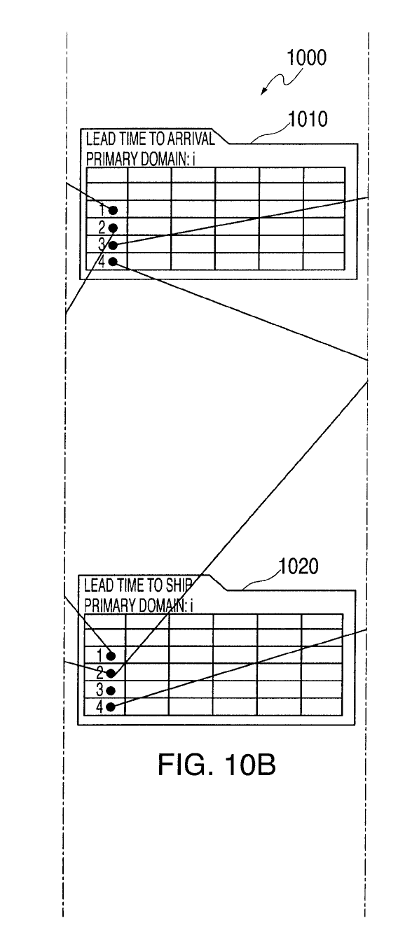

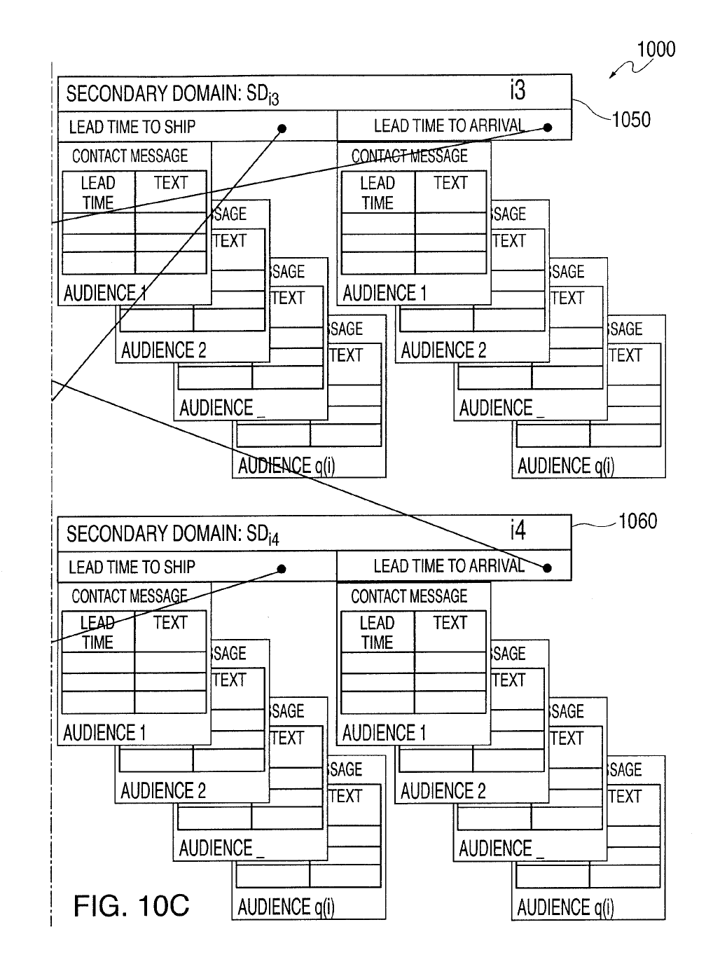

The enterprise of host system 140 determines the primary and secondary domains, the relationships between the primary and secondary domains, and the organizational elements via the parameters file component 130. The functionality of the parameters file component 130 is described further in FIGS. 4, 5, 7 and 8. FIGS. 6 and 9 illustrate logic tables used to suppress the availability messages with an appropriate “Contact the Seller” message and phone number. In instances where a toll free country phone number redirects the buyer to a call center in another country, such redirection may be transparent to the user. FIG. 10A-10C provides an illustration of the technical relationships between the primary and secondary domains.

For informational purposes, the terms provided associated with FIGS. 4 through 9 are defined below.

Primary Domain (PDᵢ) whereby i=1 to x [x is the maximum number of primary domains specified];

Ship Minimum Threshold Control Parameter (SMTCPᵢ) is a lead time to ship controlling parameter for the primary domain. It establishes the principal lower boundary over secondary domains and organizational elements and automatically suppresses the “Contact the Seller” message if the lower limit is passed;

Ship Upper Threshold Control Parameter (SUTCPᵢ) is a lead time to ship controlling parameter for the primary domain. It establishes the principal upper boundary over secondary domains and organizational elements, and automatically invokes the “Contact the Seller” message if the upper limit is exceeded;

Secondary Domain (SDᵢⱼ), whereby j=1 to s(i) [s(i) is the function of “i” and the maximum number of secondary domains specified for PDᵢ];

Ship Secondary Domain Control (SSDCᵢⱼ) is the lead time to ship secondary controlling parameter for the secondary domain;

Organizational Element (OEᵢₖ), whereby k=1 to e(i) [e(i) is the function of “i” and the maximum number of organizational elements specified for PDᵢ];

Ship Organizational Element Control (SOECᵢₖ) is the lead time to ship secondary controlling parameter for the organizational elements;

Ship Tertiary Control (STCᵢⱼₖ) is the lead time to ship tertiary controlling parameter, and temporarily overrides the SSDCᵢⱼ, SOECᵢₖ, or both;

Contact Message (CMᵢⱼₘ), whereby m=1 to q(i) [the maximum number of audiences specified for SDᵢⱼ and q(i) is the function of “i”] is the “Contact the Seller” availability message for a specific audience in a secondary domain (SDᵢⱼ), contains the applicable contact information within the availability message, and is displayed when certain availability conditions occur;

Ship Lead Time (SLTᵢⱼₘₙ), whereby n=1 to t(i) [the maximum number of availability messages specified for SDᵢⱼ and t(i) is a function of “i”] and is the lead time to ship provided by the scheduling engine for PDᵢ, SDᵢⱼ and audience “m.”

Ship Text (STᵢⱼₘₙ) converts the Ship Lead Time (SLTᵢⱼₘₙ) to an availability message for PDᵢ, SDᵢⱼ and audience “m;”

Arrival Minimum Threshold Control Parameter (AMTCPᵢ) is a lead time to arrival controlling parameter for the primary domain. It establishes the principal lower boundary over secondary domains and organizational elements and automatically suppresses the “Contact the Seller” availability message if the lower limit is passed;

Arrival Upper Threshold Control Parameter (AUTCPᵢ) is a lead time to arrival controlling parameter for the primary domain. It establishes the principal upper boundary over secondary domains and organizational elements, and automatically invokes the “Contact the Seller” availability message if the upper limit is exceeded;

Arrival Secondary Domain Control (ASDCᵢⱼ) is the lead time to arrival secondary controlling parameter for the secondary domain;

Arrival Organizational Element Control (AOECᵢₖ) is the lead time to arrival secondary controlling parameter for the organizational elements;

Arrival Tertiary Control (ATCᵢⱼₖ) is the lead time to arrival tertiary controlling parameter, and temporarily overrides the ASDCᵢⱼ, AOECᵢₖ, or both;

Arrival Lead Time (ALTᵢⱼₘₙ) is the lead time to arrival provided by the scheduling engine for PDᵢ, SDᵢⱼ and audience “m;”

Arrival Text (ATᵢⱼₘₙ) converts the Arrival Lead Time (ALTᵢⱼₘₙ) to an availability message for PDᵢ, SDᵢⱼ and audience “m.”

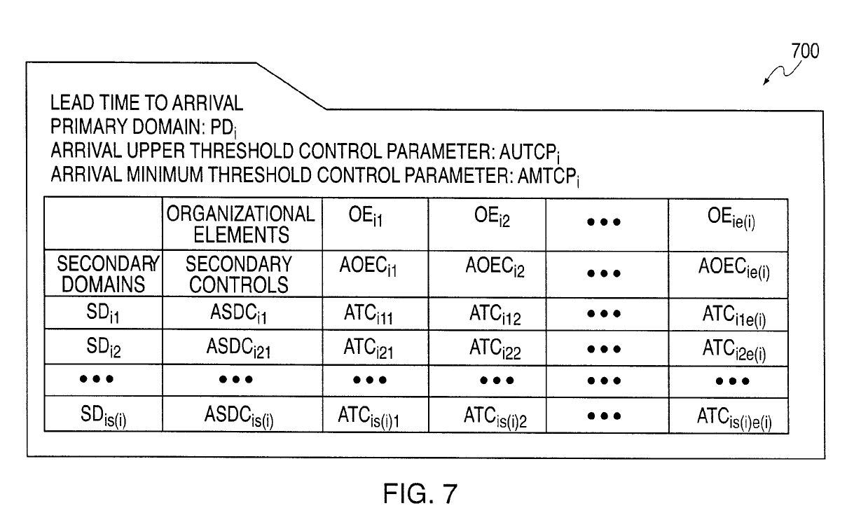

Templates 400 and 700 of FIGS. 4 and 7 are matrices of secondary domains and organizational elements that pertain to a specific primary domain for lead time to ship and lead time to arrival respectively. The templates include header information for the primary domain, and the upper primary domain control and minimum threshold control parameter. The matrices include tertiary control information that overrides the secondary control parameters.

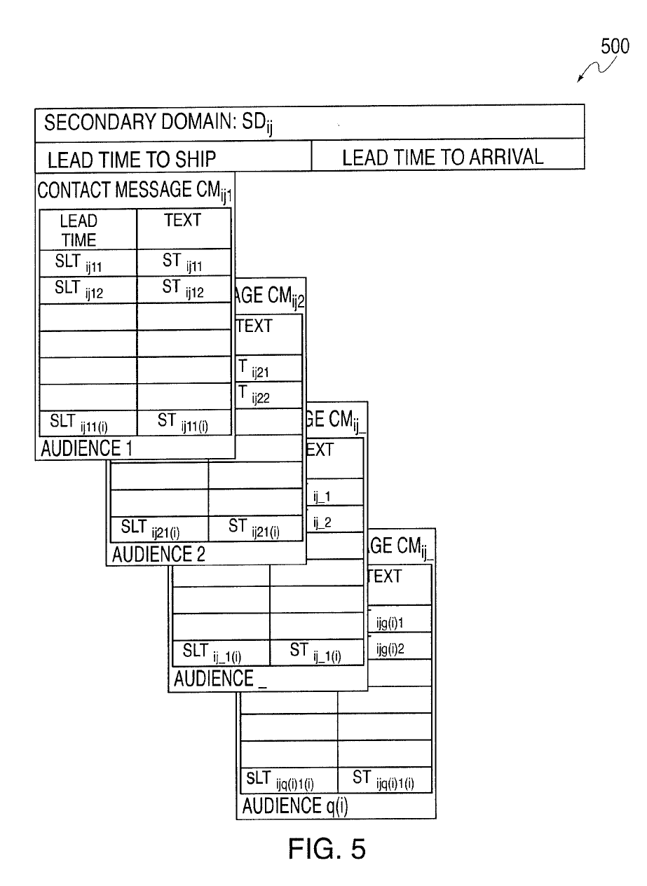

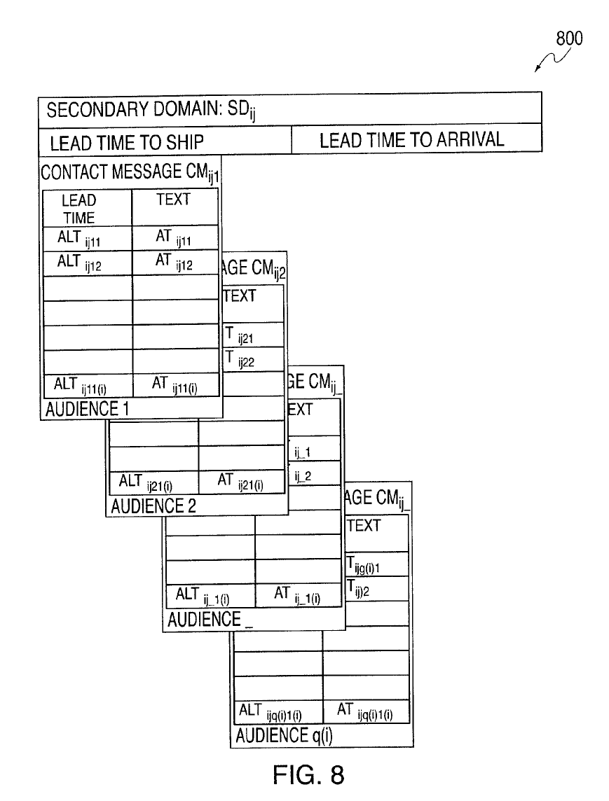

Templates 500 and 800 of FIGS. 5 and 8 are tables of lead time conditions and lead time availability for each audience for lead time to ship and lead time to arrival, respectively. Each table has header information which includes the secondary domain. There is at least one audience which is the internal sales staff and administrative support. For each audience, there may be different number of unique lead time conditions and Contact Message (CMᵢⱼₘ).

Templates 600 and 900 of FIGS. 6 and 9 are logic tables of distinct conditions and permutations for lead time to ship and lead time to arrival respectively. If all of the three conditions for one permutation are true, then the availability message from templates 500 or 800 of FIGS. 5 and 8 are overridden with the “Contact the Seller” availability message (CMᵢⱼₘ).

The component updating described above with respect to step 302 of FIG. 3 includes updating the primary, secondary and tertiary controlling parameters as exemplified in templates 400 and 700 of FIGS. 4 and 7. The templates 400 and 500 in FIGS. 4 and 5 are initialized. These initial settings are the defaults for templates 700 and 800 in FIGS. 7 and 8, respectively. Templates 400, 500, 700 and 800 of FIGS. 4, 5, 7, and 8, respectively, are initialized or updated. The supply management team provides changes as required to templates 700 and 800 in FIGS. 7 and 8 to complete the initialization process of step 302. For example, the number and content of availability messages for a secondary domain may vary for lead time to ship and lead time to arrival. The organization, e.g., may desire the “lead time to ship” of availability messages to be very precise, e.g., in days while the “lead time to arrival” to be less granular e.g., in weeks. There should always be at least one audience (internal sales staff and administrative support system 180) for every secondary domain template 500 and 800 of FIGS. 5 and 8, respectively.

The Upper Threshold Control Parameters (_UTCPᵢ) allow availability messages specified in templates 500 and 800 of FIGS. 5 and 8 to be displayed as long as the upper limit is not exceeded. This information includes Ship Text (STᵢⱼₘₙ) and Arrival Text (ATᵢⱼₘₙ), whereby i=1 to x (number of primary domains), j=1 to s(i) (number of secondary domains based on a function of “i”), m=1 to q(i) (number of audiences), and n=1 to t(i) (number of conditions for availability messages). If the upper threshold is exceeded, the appropriate secondary domain “Contact the Seller” message (CMᵢⱼₘ) is displayed.

The Minimum Threshold Control Parameter (_MTCPᵢ) prevents either the secondary or tertiary controls from displaying a “Contact the Seller” message when a typographic mistake error is made in the parameters file component 130. The application of logic tables 600 and 900 of FIGS. 6 and 9 minimizes the table maintenance of templates 400, 500, 700 and 800 of FIGS. 4, 5, 7 and 8. These templates should remain relatively static after initialization, but as changes are required, provide the necessary flexibility to rapidly change the parameters that display the appropriate availability message.

The secondary domain (_SDCᵢⱼ) and organizational element (_OECᵢⱼ) controls should be within the bounds of the upper primary domain and the minimum threshold control parameter. In certain events, the primary domain bounds may be changed to reflect current business conditions. The primary domain controls provide boundaries to the secondary controls. The tertiary controls (_TCᵢⱼₖ) provide an override mechanism of secondary domain and/or organizational element controls simultaneously, but not the primary controls. These exceptions are situationally dependent. This requires close coordination between the internal sales staff and administrative support and supply management teams. The supply management team would centrally control the information in the parameters file component 130, and the internal sales staff and administrative support would perform the implementation within the commerce engine 110.

Referring back to the flow diagram of FIG. 3, the user starts the learn, shop or buy experience at step 304, which activity is detected by the host system 140. At step 306, the user is identified by, e.g., registering themselves to the seller within the permissions component 120. The identification (registration), or lack thereof, will correlate the user to an audience, primary domain and secondary domain information. At step 308, the user invokes one or more of the catalog 122, configuration 124 or shopping cart 126 components. At step 310, the host system 140 receives a request for product or service offering information from the user, which includes availability information as part of the learn, shop and buy process, either as a lead time to ship or lead time to arrival. The seller may set either lead time to ship or lead time to arrival as the default, and may do so for each primary and secondary domain.

At step 312, the availability information request originates with the commerce engine 110 and is transmitted to the scheduling and availability component 136 via the scheduling engine 114. At step 314, the scheduling and availability component 136 returns a schedule date, either as shipment or arrival, to the commerce engine 110 via the scheduling engine 114. At step 316, the commerce engine 110 converts the schedule date (either as shipment or arrival) to a lead time to ship or lead time to arrival date.

At step 318, the commerce engine 110 provides the lead time to ship or lead time to arrival date to the parameters file component 130 for conversion to an availability message. At step 320, the parameters file component 130 evaluates the lead time information (ship or arrival), audience, primary domain, and secondary domain information using templates 400 through 900 of FIGS. 4-9 to determine the appropriate availability message. The following sequence of events is executed:

determine whether the information relates to lead time to ship or lead time to arrival dates;

if lead time to ship, templates 400, 500 and 600 of FIGS. 4-6 are accessed and the following actions are performed:

determine Primary Domain (PDᵢ), whereby i=1 to x [number of primary domains] for template 400 of FIG. 4. The primary domain information is taken from the commerce engine 110 and the permissions component 120 when the buyer either selects the primary domain, or a correlation matrix passes the primary domain information to the parameters file component 130. The primary domain (PDᵢ) identifies the Ship Upper Threshold Control Parameter (SUTCPᵢ) and Ship Minimum Threshold Control Parameter (SMTCPᵢ);

determine Secondary Domain (SDᵢⱼ), whereby j=1 to s(i) [number of secondary domains based on a function of “i”] for templates 400 and 500 of FIGS. 4 and 5. The secondary domain information is taken from the commerce engine 110 and the permissions component 120 when the buyer either selects the secondary domain, or a correlation matrix passes the secondary domain information to the parameters file component 130. The secondary domain (SDᵢⱼ) identifies the Ship Secondary Domain Control (SSDCᵢⱼ) for PDᵢ;

determine Organization Element (OEᵢₖ), where k=to e(i) [number of organizational elements based on a function of “i”] for template 400 of FIG. 4. The organization element information is taken from the catalog component 122 and is reflected in the configuration and shopping cart components, 124 and 126, respectively, when the buyer selects the product or service, or a correlation matrix passes the organizational element information to the parameters file component 130. The organizational element (OEᵢₖ) identifies the Ship Organizational Element Control (SOECᵢₖ) for PDᵢ;

evaluate the lead time to ship from step 316 to the Ship Lead Time (SLTᵢⱼₘₙ) parameter, whereby i=1 to x [number of primary domains], j=1 to s(i) [number of secondary domains], m=1 to q(i) [number of audiences], and n=1 to t(i) [number of logical conditions for availability messages]. When the lead time conditions match, the corresponding Ship Text (STᵢⱼₘₙ) is identified;

the intersection of the Secondary Domain (SDᵢⱼ) and Organization Element (OEᵢₖ) determines the Ship Tertiary Control (STCᵢⱼₖ). The default of the Ship Tertiary Control is null or blank. The business cross-functional team, in concert with the supply management team, may override the Ship Secondary Domain Control (SSDCᵢⱼ) and Ship Organizational Element Control (SOECᵢₖ) due to unique considerations, normally of a temporary nature;

apply FIG. 6 logic table rules (three conditions) to override the Ship Text (STᵢⱼₘₙ) with contact message (CMᵢⱼₘ) (i.e., “Contact the Seller” in the appropriate language) when one of the following conditions is applicable:

IF STCᵢⱼₖ is NOT null or blank AND STCᵢⱼₖ is greater than SMTCPᵢ AND SLTᵢⱼₘ is greater than the lessor of SUTCPᵢ OR STCᵢⱼₖ;

IF STC is NOT null or blank AND STCᵢⱼₖ is less than or equal to SMTCPᵢ AND SLTᵢⱼₘₙ is greater than SMTCPᵢ,

IF STCᵢⱼₖ is null or blank AND the lessor of [SUTCPᵢ, SSDCᵢⱼ or SOECᵢₖ] is greater than SMTCPᵢ AND SLTᵢⱼₘₙ is greater than the lessor of [SUTCPᵢ, SSDCᵢⱼ or SOECᵢₖ]; OR

IF STCᵢⱼₖ is null or blank AND the lessor of [SUTCPᵢ, SSDCᵢⱼ or SOECᵢₖ] is less than or equal to SMTCPᵢ AND SLTᵢⱼₘₙ, is greater than SMTCPᵢ.

NOTE: ‘IF’, ‘AND’, ‘NOT’, and ‘OR’ indicate logical operations.

if the lead time information relates to lead time to arrival, templates 700, 800 and 900 of FIGS. 7-9 are accessed and the following actions are taken:

determine Primary Domain (PDᵢ), whereby i=1 to x [number of primary domains] for template 700 of FIG. 7. The primary domain information is taken from the commerce engine 110 and the permissions component 120 when the buyer either selects the primary domain, or a correlation matrix passes the primary domain information to the parameters file component 130. The primary domain (PDᵢ) identifies the Arrival Upper Threshold Control Parameter (AUTCPᵢ) and Arrival Minimum Threshold Control Parameter (AMTCPᵢ);

determine Secondary Domain (SDᵢⱼ), whereby j=1 to s(i) [number of secondary domains based on a function of “i”] for templates 700 and 800 of FIGS. 7 and 8. The secondary domain information is taken from the commerce engine 110 and the permissions component 120 when the buyer either selects the secondary domain, or a correlation matrix passes the secondary domain information to the parameters file component 130. The secondary domain (SDᵢⱼ) identifies the Arrival Secondary Domain Control (ASDCᵢⱼ) for PDᵢ;

determine Organization Element (OEᵢₖ), where k=to e(i) [number of organizational elements based on a function of “i”] for template 700 of FIG. 7. The organization element information is taken from the catalog, configuration, or shopping cart components 122-126, respectively, when the buyer selects the product or service, or a correlation matrix passes the organizational element information to the parameters file component 130. The organizational element (OEᵢₖ) identifies the Arrival Organizational Element Control (AOECᵢₖ) for PDᵢ;

evaluate the lead time to arrival from step 316 to the Arrival Lead Time (ALTᵢⱼₘₙ) parameter, whereby i=1 to x [number of primary domains], j=1 to s(i) [number of secondary domains], m=1 to q(i) [number of audiences], and n=1 to t(i) [number of logical conditions for availability messages]. When the lead time conditions match, the corresponding Arrival Text (ATᵢⱼₘₙ) is identified;

the intersection of the Secondary Domain (SDᵢⱼ) and Organization Element (OEᵢₖ) determines the Arrival Tertiary Control (ATCᵢⱼₖ). The default of the Arrival Tertiary Control is null or blank. The business cross-functional team in concert with the supply management team may override the Arrival Secondary Domain Control (ASDCᵢⱼ) and Arrival Organizational Element Control (AOECᵢₖ) due to unique considerations, normally of a temporary nature;

FIG. 9 logic table rules (three conditions) are applied to override the Arrival Text (ATᵢⱼₘₙ) with contact message (CMᵢⱼₘ) (i.e., “Contact the Seller” in the appropriate language) when one of the following conditions is applicable:

IF ATCᵢⱼₖ is NOT null or blank AND ATCᵢⱼₖ is greater than AMTCPᵢ AND ALTᵢⱼₘₙ is greater than the lessor of AUTCPᵢ OR ATCᵢⱼₖ;

IF ATCᵢⱼₖ is NOT null or blank AND ATCᵢⱼₖ is less than or equal to AMTCPᵢ AND ALTᵢⱼₘₙ is greater than AMTCPᵢ;

IF ATCᵢⱼₖ is null or blank AND the lessor of [AUTCPᵢ, ASDCᵢⱼ or AOECᵢₖ] is greater than AMTCPᵢ AND ALTᵢⱼₘₙ is greater than the lessor of [AUTCPᵢ, ASDCᵢⱼ or AOECᵢₖ]; OR

IF ATCᵢⱼₖ, is null or blank AND the lessor of [AUTCPᵢ, ASDCᵢⱼ or AOECᵢₖ] is less than or equal to AMTCPᵢ AND ALTᵢⱼₘₙ is greater than AMTCPᵢ

NOTE: ‘IF’, ‘AND’, ‘NOT’, and ‘OR’ indicate logical operations.

The diagram 1000 of FIG. 10A-10C illustrates an example of the relationships between FIGS. 4, 5, 7 and 8 which are hierarchical. For purpose of illustration, the primary domain “i” has two lead time templates. Lead time to arrival (item 1010) and lead time to ship (item 1020) templates correlate to templates 400 and 700 of FIGS. 4 and 7, respectively. Both lead time templates are connected to four secondary domains, ii (item 1030), i2 (item 1040), i3 (item 1050) and i4 (item 1060). There are four secondary domains are directly associated with the primary domain. The secondary domain lead time to ship and lead time to arrival tables (templates 500 and 800 of FIGS. 5 and 8) are combined since the header information is common to both message tables. Diagram 1000 of FIG. 10A-10C illustrates the one to many relationships between the primary and secondary domains.

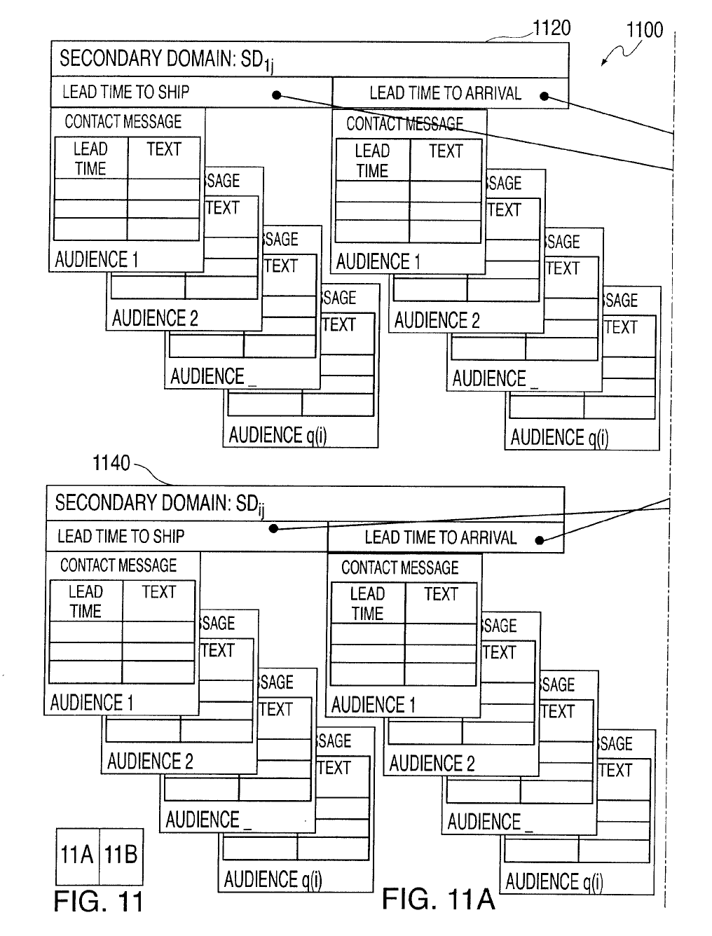

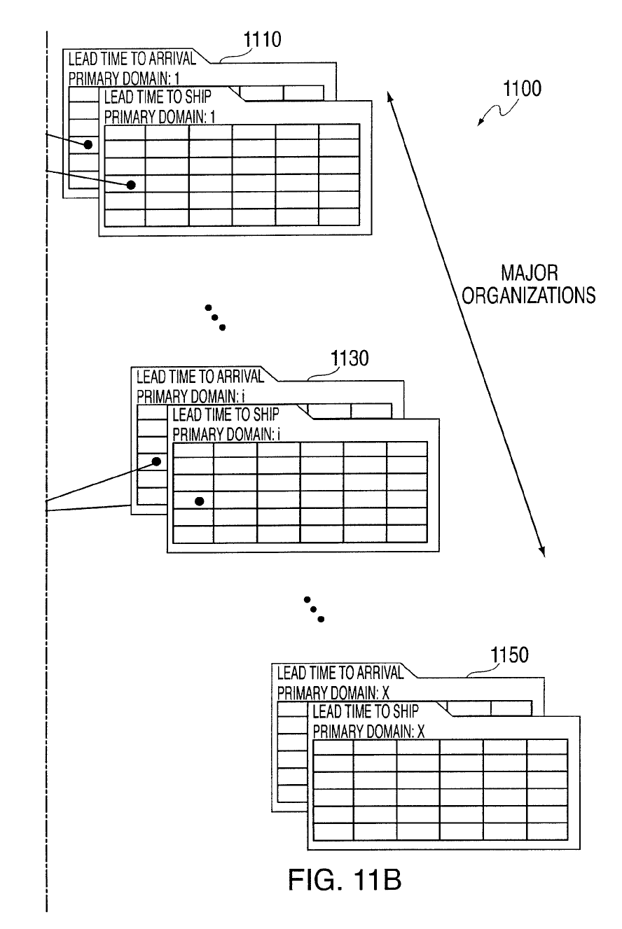

Diagram 1100 of FIG. 11A-11B illustrates another example of the relationships between FIGS. 4, 5, 7 and 8. Two or more primary domains are established for an enterprise. For purposes of illustration, items 1110, 1130 and 1150 represent three organizations within the enterprise. For each primary domain, there may be multiple secondary domains unique to other secondary domains within the hierarchy. For purposes of illustration, item 1120 is one of many secondary domains for item 1110, and item 1140 is one of many secondary domains for item 1130. Diagram 1100 of FIG. 11A-11B illustrates the breadth of the primary and secondary domains.

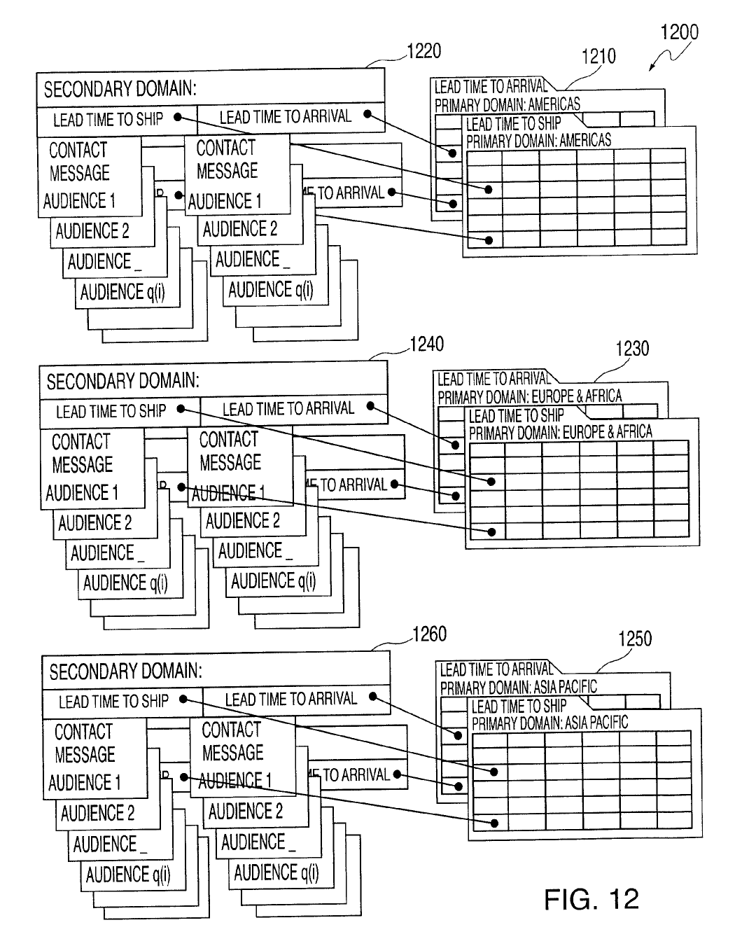

Diagram 1200 of FIG. 12 illustrates an example application of the diagram 1100 of FIG. 11A-11B, which shows the three geographic elements (primary domains) of a worldwide enterprise: Americas (item 1210), Europe and Africa (item 1230) and Asia Pacific (item 1250). Each primary domain has multiple secondary domains unique to those geographies. Additionally, the audiences, availability lead times, and availability messages may vary due to sources of supply and business practices. The Americas geography (item 1210) is connected to multiple secondary domains (item 1220).

The Europe and Africa geography (item 1230) is connected to multiple secondary domains (item 1240). The Asia Pacific geography (item 1250) is connected to multiple secondary domains (item 1260). The secondary domains in this illustration are based on countries and languages. This method is adaptable to other means of dividing and subdividing an enterprise.

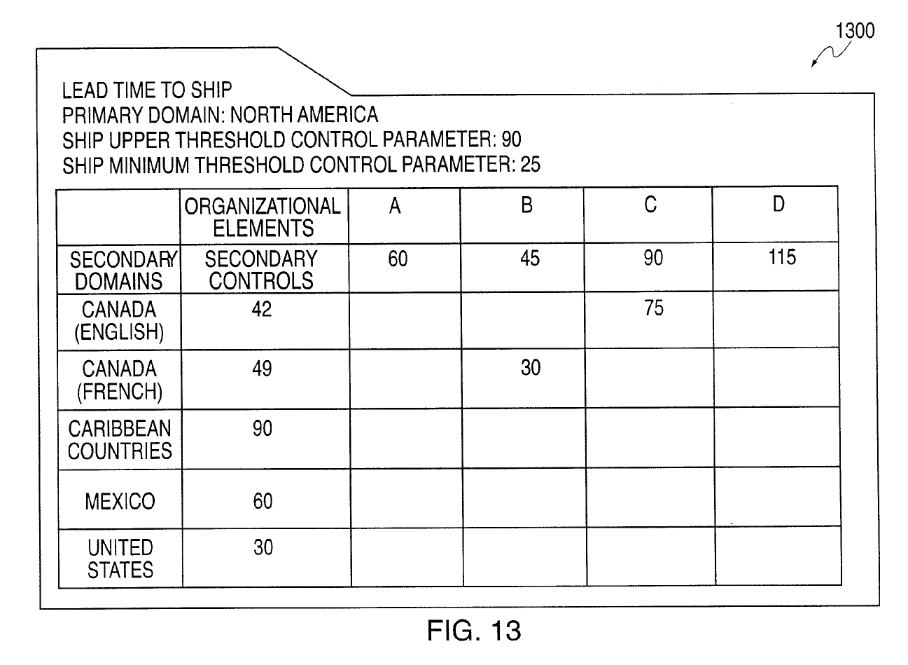

Illustration 1300 of FIG. 13 is a lead time to ship matrix with sample data. The ship upper primary domain control (SUTCPᵢ) is set to 90 days, with the Ship Minimum Threshold Control Parameter (SMTCPᵢ) is set to 25 days. There are five secondary domains: Canada (English and French), Caribbean countries, Mexico, and the United States. There are four organizational elements within the enterprise, represented by the letters “A,” “B,” “C,” and “D.”

Regardless of the secondary and tertiary controls, any availability above the upper primary control (_UTCP) will have a “Contact the Seller” availability message. Additionally, the Minimum Threshold Control Parameter (_MTCP) ensures that for all availability less than the _MTCP will display the availability message (_Tᵢⱼₘₙ). In the event that one of the secondary domains inadvertently sets the parameter to less than 25 days, the “Contact the Seller” availability will not be displayed.

There are two exceptions where tertiary controls may be implemented. These two cases are for Canada (English) and organizational element “C,” and Canada (French) and organizational element “B.” In the Canada (English) and organizational element “C” case, the secondary domain control is being raised, and the organizational element control is lowered. In the Canada (French) and organizational element “B” case, the secondary domain and organizational element controls are lowered.

Returning now to the flow diagram of FIG. 3, the parameters file component 130 sends the appropriate availability message to the commerce engine 110 and to the user at step 322. At step 324, it is determined whether the buyer chooses to continue the learn, shop or buy experience. If so, it is determined whether the buyer wishes to purchase the product/service at step 326. If ‘yes’, the buyer proceeds to step 328 and the order is submitted. The order is transmitted from the commerce engine 110 to the order management component 132 via the ERP engine 112. At step 330, the order management component 132 provides booked order information to the scheduling and availability component 136 via the ERP Engine 112 and scheduling engine 114 for a netted supply determination which may change future schedule dates provided. The process then ends at step 322.

Alternatively, if the buyer does not choose to purchase the product or service, the buyer is redirected to the learn, shop or buy experience at step 304. Returning to step 324, if the buyer does not wish to continue with the learn, shop, or buy experience, the process ends at step 322.

As described above, the embodiments of the invention may be embodied in the form of computer-implemented processes and apparatuses for practicing those processes. Embodiments of the invention may also be embodied in the form of computer program code containing instructions embodied in tangible media, such as floppy disks, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Those skilled in the art would appreciate that the method, system and templates within the invention can be adapted and extended to lead time to installation when a more robust installation scheduling capability is developed. The “Contact the Seller” availability message for installation may be different from lead time to ship or lead time to arrival.

What is claimed is:

1. A method for implementing availability messaging services, comprising:
associating a user with an audience type with respect to an entity, the entity providing at least one product or service;
defining and applying at least one domain to each audience type operable for differentiating among audience types;
determining a corresponding schedule date for the at least one product or service in response to receiving a request for availability information regarding the at least one product or service;
converting the schedule date to at least one of a lead time to ship date and a lead time to arrival date;
generating an availability message based upon the audience type of the user, the availability message including the at least one of the lead time to ship date and the lead time to arrival date; and
transmitting the availability message to the user.

2. The method of claim 1, wherein the at least one domain includes a primary domain and a secondary domain, the generating an availability message for the lead time to ship date including:
determining the primary domain that identifies upper and lower minimum threshold control parameters for shipping set by the entity in accordance with the audience type of the user;
determining the secondary domain that identifies secondary domain control parameters for shipping set by the entity in accordance with the audience type of the user;
comparing the lead time to ship date with a ship lead time parameter set by the entity, the lead time parameter linked to a corresponding message;
using the corresponding message in the availability message when the lead time to ship date matches the ship lead time parameter.

3. The method of claim 2, further comprising:
overriding the ship lead time parameter operable for providing an alternative message upon the occurrence of designated conditions.

4. The method of claim 1 wherein the at least one domain includes a primary domain and a secondary domain, the generating an availability message for the lead time to arrival date including:
determining the primary domain that identifies upper and lower minimum threshold control parameters for arrivals set by the entity in accordance with the audience type of the user;
determining the secondary domain that identifies secondary domain control parameters for arrivals set by the entity in accordance with the audience type of the user;
comparing the lead time to arrival date with an arrival lead time parameter set by the entity, the arrival lead time parameter linked to a corresponding message;
using the corresponding message in the availability message when the lead time to arrival date matches the arrival lead time parameter.

5. The method of claim 4, further comprising:
overriding the arrival lead time parameter operable for providing an alternative message upon the occurrence of designated conditions.

6. The method of claim 1, wherein the request for availability information regarding the at least one product or service results from at least one of a learn, shop, and buy experience conducted via the entity.

7. The method of claim 1, wherein the primary domain differentiates audience types by geography.

8. The method of claim 1, wherein the secondary domain differentiates audience types by at least one of geographic or political entity, and language spoken.

9. A system for implementing availability messaging services, comprising:
a host system in communication with a user system via a network; and
an application executing on the host system, the application performing:
associating a user of the user system with an audience type with respect to an entity of the host system, the entity providing at least one product or service;
defining and applying at least one domain to each audience type operable for differentiating among audience types;
determining a corresponding schedule date for the at least one product or service in response to receiving a request for availability information regarding the at least one product or service;
converting the schedule date to at least one of a lead time to ship date and a lead time to arrival date;
generating an availability message based upon the audience type of the user, the availability message including the at least one of the lead time to ship date and the lead time to arrival date; and
transmitting the availability message to the user system.

10. The system of claim 9, wherein the at least one domain includes a primary domain and a secondary domain, the generating an availability message for the lead time to ship date including:
determining the primary domain that identifies upper and lower minimum threshold control parameters for shipping set by the entity in accordance with the audience type of the user;
determining the secondary domain that identifies secondary domain control parameters for shipping set by the entity in accordance with the audience type of the user;
comparing the lead time to ship date with a ship lead time parameter set by the entity, the lead time parameter linked to a corresponding message;
using the corresponding message in the availability message when the lead time to ship date matches the ship lead time parameter.

11. The system of claim 10, wherein the application further performs:
overriding the ship lead time parameter operable for providing an alternative message upon the occurrence of designated conditions.

12. The system of claim 9, wherein the at least one domain includes a primary domain and a secondary domain, the generating an availability message for the lead time to arrival date including:
determining the primary domain that identifies upper and lower minimum threshold control parameters for arrivals set by the entity in accordance with the audience type of the user;
determining the secondary domain that identifies secondary domain control parameters for arrivals set by the entity in accordance with the audience type of the user;
comparing the lead time to arrival date with an arrival lead time parameter set by the entity, the arrival lead time parameter linked to a corresponding message;
using the corresponding message in the availability message when the lead time to arrival date matches the arrival lead time parameter.

13. The system of claim 12, wherein the application further performs:
overriding the arrival lead time parameter operable for providing an alternative message upon the occurrence of designated conditions.

14. The system of claim 9, wherein the request for availability information regarding the at least one product or service results from at least one of a learn, shop, and buy experience conducted via the entity.

15. The system of claim 9, wherein the primary domain differentiates audience types by geography.

16. The system of claim 9, wherein the secondary domain differentiates audience types by at least one of geographic or political entity, and language spoken.

17. A computer program product for implementing availability messaging services, the computer program product including instructions for performing a method, the method comprising:
associating a user with an audience type with respect to an entity, the entity providing at least one product or service;
defining and applying at least one domain to each audience type operable for differentiating among audience types;
determining a corresponding schedule date for the at least one product or service in response to receiving a request for availability information regarding the at least one product or service;
converting the schedule date to at least one of a lead time to ship date and a lead time to arrival date;
generating an availability message based upon the audience type of the user, the availability message including the at least one of the lead time to ship date and the lead time to arrival date; and
transmitting the availability message to the user.

18. The computer program product of claim 17, wherein the at least one domain includes a primary domain and a secondary domain, the generating an availability message for the lead time to ship date including:
determining the primary domain that identifies upper and lower minimum threshold control parameters for shipping set by the entity in accordance with the audience type of the user;
determining the secondary domain that identifies secondary domain control parameters for shipping set by the entity in accordance with the audience type of the user;
comparing the lead time to ship date with a ship lead time parameter set by the entity, the lead time parameter linked to a corresponding message;
using the corresponding message in the availability message when the lead time to ship date matches the ship lead time parameter.

19. The computer program product of claim 18, further comprising instructions for performing:
overriding the ship lead time parameter operable for providing an alternative message upon the occurrence of designated conditions.

20. The computer program product of claim 17, wherein the at least one domain includes a primary domain and a secondary domain, the generating an availability message for the lead time to arrival date including:
determining the primary domain that identifies upper and lower minimum threshold control parameters for arrivals set by the entity in accordance with the audience type of the user;
determining the secondary domain that identifies secondary domain control parameters for arrivals set by the entity in accordance with the audience type of the user;
comparing the lead time to arrival date with an arrival lead time parameter set by the entity, the arrival lead time parameter linked to a corresponding message;
using the corresponding message in the availability message when the lead time to arrival date matches the arrival lead time parameter.

21. The computer program product of claim 20, further comprising instructions for performing:
overriding the arrival lead time parameter operable for providing an alternative message upon the occurrence of designated conditions.

22. The computer program product of claim 17, wherein the request for availability information regarding the at least one product or service results from at least one of a learn, shop, and buy experience conducted via the entity.

23. The computer program product of claim 17, wherein the primary domain differentiates audience types by geography.

24. The computer program product of claim 17, wherein the secondary domain differentiates audience types by at least one of geographic or political entity, and language spoken.
